(19) United States
(12) Patent Application Publication
(10) Pub. No.: US 2003/0147528 A1
(43) Pub. Date: Aug. 7, 2003

(54) Protective phone cover and method of using same

(76) Inventor: Raymond Pfaff, Carter Lake, IA (US)

Correspondence Address: LAW OFFICES OF ADAM H. JACOBS, SUITE 726, 1904 FARNAM STREET, OMAHA, NE, 68102, US

(21) Appl. No.: 10/325,393

(22) Filed: Dec. 19, 2002

Related U.S. Application Data
(60) Provisional application No. 60/342,025, filed on Dec. 19, 2001.

(51) Int. Cl. H04M 1/00

(52) U.S. Cl. 379/451; 379/452

(57) ABSTRACT

A protective phone cover for mounting on a phone includes a generally hemispherical cover sheet having a top panel and side walls and a securement device such as an elastic band mounted on the generally hemispherical cover sheet for releasably securing the cover sheet to a phone. The top panel of the cover sheet being spaced from the surface of the phone whereby the top panel is movable relative to the phone to permit sound conduction thereby.

### CROSS-REFERENCE TO RELATED APPLICATION

This application claims priority to the filing date of related patent application Ser. No. 60/342,025 filed Dec. 19, 2001.

### BACKGROUND OF THE INVENTION

1. Technical Field

The present invention relates to sanitary covers for phone handsets and, more particularly, to a protective cover for a telephone handset and a method of using the same which includes a paper or fabric generally hemispherical cover having an elastic ring mounted on the lower open end thereof for releasably securing the cover on either end of the telephone handset, the method including the steps of stretching the elastic ring thus dilating the lower open end of the cover, placing the cover over the end of the telephone to be covered, releasing the elastic ring such that the cover is releasably secured on the phone and removing and discarding the cover after the phone has been used.

2. Description of the Prior Art

There are an almost uncountable number of telephones in use today throughout the world, and these are in use in almost every conceivable location and situation. Many of the telephones in use are either public phones, such as pay phones or other such public accessible phones, or are used by several different people within a relatively short period of time. In both of these situations, and in numerous others, subsequent users of the telephone are potentially being exposed to whatever germs the previous user or users left on the handset, both on the receiving end and the transmitting end. Obviously, these uses are potentially unsanitary and can result in the spread of infection. There is therefore a need for a device which is capable of reducing the risk of infection yet is disposable for ease of use.

There are several prior art devices which disclose devices which at first glance appear similar to the present invention, yet with review reveal that they include significant distinguishing characteristics. For example, Harrison, U.S. Pat. No. 5,930,356, discloses a telephone handset cover, as do Lo et al., U.S. Pat. No. 5,054,063 and Lashley, U.S. Pat. No. 6,314,185. Each of these devices, when used as intended, however, results in the muffling of sound due to the relative immobility of the protective cover. Either that, or in the case of Lashley, the cover includes a perforation to permit the sound waves to pass through. There is therefore a need for a protective cover which not only serves the purposes stated above, but generally acts to prevent muffling or distortion of the sound passing therethrough.

Therefore, an object of the present invention is to provide an improved protective phone cover.

Another object of the present invention is to provide an improved protective phone cover which includes a generally hemispherical cover sheet, a securement device such as an elastic band or the like and an impregnation substance which will increase the antibacterial nature of the invention.

Another object of the present invention is to provide an improved protective phone cover which includes an air gap between the phone surface and the cover sheet in order to permit the cover sheet to vibrate in conjunction with the motion of the phone diaphragm.

Finally, an object of the present invention is to provide an improved protective phone cover which is cost-effective and durable in manufacture and is simple and efficient in use.

### SUMMARY OF THE INVENTION

The present invention provides a protective phone cover for mounting on a phone includes a generally hemispherical cover sheet having a top panel and side walls and a securement device such as an elastic band mounted on the generally hemispherical cover sheet for releasably securing the cover sheet to a phone. The top panel of the cover sheet being spaced from the surface of the phone whereby the top panel is movable relative to the phone to permit sound conduction thereby.

It is thus seen that the present invention provides a substantial improvement over those inventions found in the prior art. For example, many of the devices found in the prior art address only the issue of disease prevention, but do not address the issue of sound conduction. Furthermore, as the present invention is relatively simple and inexpensive in manufacture and is durable in use, the user may quickly apply and remove the cover of the present invention as opposed to the methods of application required by many of the devices found in the prior art. The present invention thus provides a substantial improvement over the prior art.

### BRIEF DESCRIPTION OF THE DRAWINGS

FIG. 1 is a perspective view of the protective cover of the present invention mounted on a telephone;

FIG. 2 is a side elevational view of the protective cover of the present invention;

FIGS. 3 and 4 illustrate the method of using the protective cover of the present invention with a telephone handset; and

FIG. 5 shows how the cover sheet, due to its spacing from the phone, moves with the sound emanations coming from the phone unit.

### DESCRIPTION OF THE PREFERRED EMBODIMENT

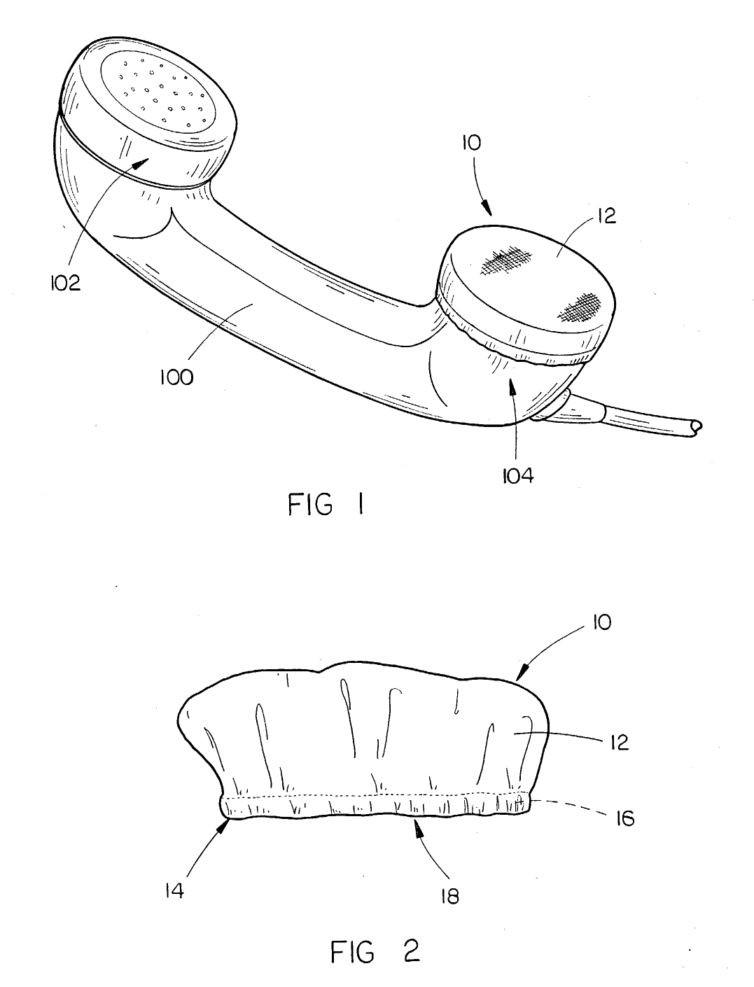

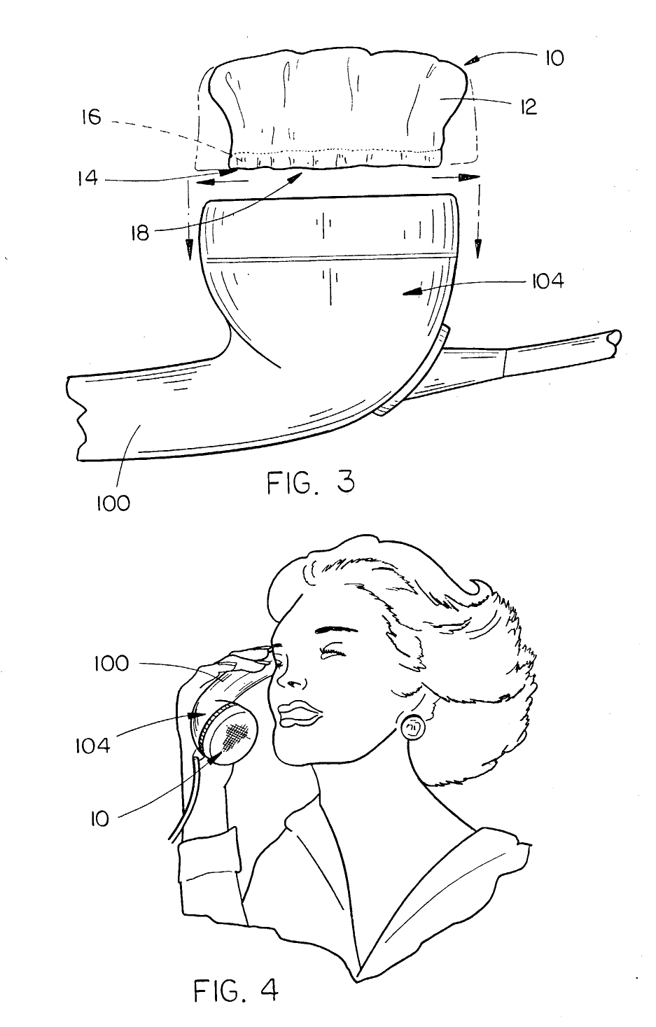

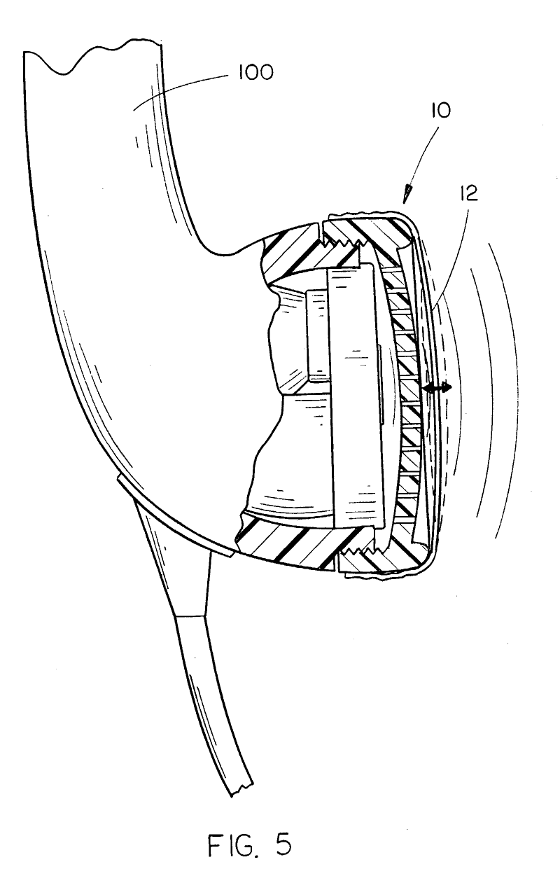

The protective phone cover 10 of the present invention is best shown in FIGS. 1 and 2 as consisting of a flexible paper or fabric generally hemispherical cover sheet 12 which is approximately two to two and a half inches (2″ to 2½″) in diameter and has a depth of approximately one to two inches (1″to 2″). In the preferred embodiment, the cover sheet 12 would be constructed having a thickness between 0.1 and 3 millimeters which permits the cover sheet 12 to pass sound therethrough yet helps to filter and prevent the transmission of bacteria, viruses and other contaminants through the cover sheet 12. Of course, it is to be understood that the cover sheet 12 may be constructed of many different materials so long as the sound permeation feature of the cover sheet 12 is maintained, any of which are known in the prior art and would be usable by one skilled in the art.

In the preferred embodiment, the lower edge 14 of the cover sheet 12 is generally circular and mounted thereon is an elastic ring 16 which extends circumferentially around the lower edge 14 of the cover 10 and constricts the lower opening 18 of cover 10. It is preferred that the elastic ring 16 be constructed as a thin band or cord of elastic material which can be stretched to increase the diameter of the lower opening 18 to fit over and onto an end 102 of a telephone handset 100, the elastic ring 16 then constricting the lower opening 18 after release thereof to releasably secure the cover 10 on the telephone handset 100.

An important feature of the present invention is that due to the fabric or paper nature of the cover sheet 12, it is relatively simple to impregnate the cover sheet 12 with an antibacterial solution which will act as a disinfectant when the cover 10 is being used on the telephone handset. The strength and nature of the disinfectant is variable, depending on the intended use of the cover 10 and the sensitivity level of the individual using the device, although it is preferred that the cover sheet 12 include some form of disinfectant regardless of the above factors. In this manner, any germs remaining on the handset from the previous user of the telephone will be prevented from entering the present user's system, thus decreasing the likelihood of infection and promoting use of public telephones, particularly pay phones.

Regarding the method of use of the present invention, the user would take the cover 10 and dilate the lower opening 18 thus tensioning the elastic ring 16. The cover 10 would then be fitted onto either the receiving end 102 or the transmitting end 104 of the handset 100 with the chosen end sliding into the lower opening 18. The user would then release the elastic ring 16, thus permitting the ring 16 to retract and constrict the lower opening 18 until the body of the handset 100 adjacent the chosen end is contacted. The frictional contact between the handset 100 and the cover 10 releasably secures the cover 10 thereon, and after the telephone call has been made, the user simply removes and discards the cover 10 thus preparing the telephone for the next user.

An important feature of the present invention is that the cover sheet 12 is spaced from the top surface of the phone to permit the cover sheet 12 to move in response to sound waves emanating from the phone itself. In this manner, the sound waves are not muffled due to the immobility of the phone cover as is seen in the devices of the prior art. In fact, it is

It should be noted that as there are various sizes and shapes of telephone handsets, the exact dimensions of cover 10 may be modified to accommodate these types of handsets, but the variations will be small in nature and the modifications will not be difficult to incorporate. It is further noted that the size and shape of the cover 10 is not critical so long as the intended function of securing the cover 10 on the handset is maintained. Of course, modifications to the size, shape and design of the cover 10 are well within the broad scope of the present disclosure. It should be further noted that numerous modifications, additions and substitutions to the protective cover for telephone handsets and method of applying the same of the present invention may be made which likewise fall within the intended broad scope of the present disclosure. For example, the construction material used for the cover 10 may be modified so long as the functional characteristics of the devices are not greatly modified. Finally, the method of applying cover 10 to the telephone handset 100 may be modified and changed so long as the intended result of protecting the user of the telephone is generally maintained.

There has therefore been shown and described a protective cover for telephone handsets and method of using the same which accomplishes at least all of its intended objectives.

I claim:

1. A protective phone cover for mounting on a phone comprising:
a generally hemispherical cover sheet having a top panel and side walls;
securement means mounted on said generally hemispherical cover sheet for releasably securing said cover sheet to a phone; and
said top panel of said cover sheet being spaced from the surface of said phone whereby said top panel is movable relative to the phone to permit sound conduction thereby.
